(19) United States
(12) Patent Application Publication
(10) Pub. No.: US 2014/0007488 A1
(43) Pub. Date: Jan. 9, 2014

(54) Passive Flycatcher

(71) Applicant: Frank M. Calabrese, Austin, TX (US)

(72) Inventor: Frank M. Calabrese, Austin, TX (US)

(21) Appl. No.: 13/936,304

(22) Filed: Jul. 8, 2013

Related U.S. Application Data
(60) Provisional application No. 61/689,010, filed on Jul. 9, 2012.

(51) Int. Cl. A01M 1/16; A01M 1/10

(52) U.S. Cl. CPC A01M 1/16; A01M 1/106
USPC 43/115; 29/428

(57) ABSTRACT

The present invention describes a new and improved fly catching device that does not require the active participation of the user, or any chemicals or pollutants that might cause harm to the user, their pets, or livestock. The flycatcher is designed to attract flies such as Horseflies and Greenhead flies, which are known to fly low to the ground and fly upwards to attack and bite livestock and humans from below. The fly catching device has a rectangular design and includes a foldable single piece frame having openings on the sides that encourage the entry of aggressive insects, such as flies, that believe the sides of the device are the legs of livestock or humans. The fly catching device of further includes upper surface openings that are covered by an adhesive material designed to catch and contain the flies thereon.

### CROSS REFERENCE TO RELATED APPLICATION

This application claims the benefit of U.S. Provisional Application No. 61/689,010 filed on Jul. 9, 2012, entitled “Passive Flycatcher.” The above identified patent application is herein incorporated by reference in its entirety to provide continuity of disclosure.

### BACKGROUND OF THE INVENTION

1. Field of the Invention

The present invention relates to insect catching devices. More specifically the invention relates to a passive flycatcher device having side openings and an upper section adapted for capturing flies.

Insect infestations are a common occurrence in all areas of the world, and the problems that insects cause only increase during the warm seasons. These pests can cause serious harm to livestock and humans, carry and transfer a multitude of diseases, destroy a person's property and are generally just an annoyance. The annoyance and monetary damages that insects cause are multiplied during the summer months when the insects are most active. Compounding these issues and as a result of increased average temperatures in recent years, the quantity and duration that the insects remain active has greatly increased.

The most popular form of clearing an area of insects is by way of a simple fly swatter. The drawback of using a flyswatter is that it requires an action on the part of the user, and the success rate of using a flyswatter depends on the vision and the skill of the user. Moreover, a flyswatter is only a suitable device when in a confined setting such as a home or office setting and the number of flies in the area is limited. Any devices that require the active participation of a user to trap or eliminate insects is inconvenient for use in an outside setting where insects are numerous.

Insects can cause many problems when they reside in great numbers in an unconfined area. To solve these issues, many devices have been designed to exterminate, repel, or trap insects that can cause damage and other issues to livestock, people, and property. These traps do not require active participation on the part of a user, and the traps typically use food, visual lures, bright colors and shapes, and chemicals to attract the insects to the traps or repel the insects from an area. The traps vary in their design to enable one to trap different insect species, wherein each is adapted to prevent the insects from leaving after entering the traps.

Flies are one of the most common nuisances for those who spend time outdoors. Flies of the genus Tabanus, in particular Horseflies and Greenhead flies, cause the most issues for people because they are capable of inflicting multiple painful bites on people and livestock, and the flies are extremely agile when flying. Since the bites from Horseflies and Greenhead flies are more immediately noticeable than that of mosquitos, it is even more of an annoyance to the person. The females of the flies are anautogenous, meaning they require a blood meal before they are able to reproduce effectively. During breeding times, attacks can greatly increase. Along with the pain of the bites also comes with it the exposure to blood-borne diseases, which is a risk for both animals and humans. Therefore, to combat these known problems and over infestation, an effective flytrap is needed that can more readily trap these flies.

There exist several devices that are configured for catching flies. These devices come in the form of boxes containing adhesives and cones that prevent the escape of the flies once they enter the device. These devices use foods, fly attracting proteins, certain shapes, pheromones and other chemicals to attract the flies into the traps. The setback of many of these systems is that they often have difficulty in attracting horseflies and greenhead flies that are focused on attacking and feeding on an animal or person for their blood prior to laying eggs. The devices in the prior art additionally tend to be overly bulky and use a mesh screen to trap flies, whereafter catching the flies the devices lack a convenient means for disposal of the flies. What is needed is a fly capturing device configured for attracting blood-seeking flies from the Genus Tabanus, in particular Horseflies and Greenhead flies, such that the device adequately attracts the fly, captures the fly therein, and then offers the user a ready means of removing the dead flies and re-establishing the catcher.

The present invention relates to a device for attracting flies of the genus Tabanus, in particular horseflies and greenhead flies. The device attracts, catches, and retains the flies for later disposal, and lures the flies by its construction and dark color, without the use of chemicals that might harm the user, livestock, or pets. The device is constructed of a single piece of material that is folded and secured together into the shape of a rectangular box. The box attracts flies by having cutouts in the rectangular box that are adapted to resemble the legs of livestock. Since Horseflies and Greenhead flies are anautogenous, they must have blood before laying their eggs, and thus a box that resembles the legs of livestock appear to be an attractive place to attack. The device further comprises a clear adhesive on its upper surface that permits the flies to view the sunlight from within the box. The flies fly upward believing they are attacking the livestock and become attached to the adhesive material until removed from the box at a later time, wherein the adhesive is peeled away and replaced for reuse of the trap. In this way the present invention is configured to attract and catch Horseflies and Greenhead flies.

### DESCRIPTION OF THE PRIOR ART

Devices have been disclosed in the prior art that relate to fly catchers. These include devices that have been patented and published in patent application publications. These devices generally relate to fly catchers that attract flies by providing a source of food, colors and chemicals in a device that prevents the flies to escape after they enter the device. The following is a list of devices deemed most relevant to the present disclosure, which are herein described for the purposes of highlighting and differentiating the unique aspects of the present invention, and further highlighting the drawbacks existing in the prior art.

Specifically U.S. Pat. No. 4,074,457 to Sato teaches an insect catching assembly having a fluorescent lamp for attracting flying insects. The assembly further includes an adhesive strip positioned proximally to the lamp and a collecting pan detachably attached to the assembly. Although the insect catching assembly of Sato of similar in nature and relevant to the present invention, it differs in that it fails to provide a boxed design having cutouts to resemble the legs of an animal, and further lacks a frame having a single piece folded to complete the box-shaped design.

U.S. Pat. No. 5,363,589 to Flynn describes a fly catcher having a mating relationship between a tapered pathway for the entry of flies, and a chamber for the capture of flies. The tapered passageway guides flies into the chamber, wherein the chamber holds the flies that enter the interior of the chamber via an exit port of the passageway. While the fly catcher of Flynn is similar in nature and relevant to the present invention, it differs in that its design attracts flies by using bait instead of attracting flies who believe they are attacking the legs of livestock.

U.S. Pat. No. 5,950,355 to Gilbert describes a flying insect trap having a frame-like enclosure including an insect-attracting light source and an adhesive surface. An opening in the enclosure provides access to the interior of the device, wherein insects who are attracted to the light source become secured to the adhesive surface in the fly trap. While the flying insect trap of Gilbert is similar in nature and relevant to the present invention, it differs in that it fails to include a frame having a single piece and further differs in that it fails to attract flies who believe they are attacking the legs of livestock.

U.S. Pat. No. 7,788,845 to Nelson describes a fly trap with multiple light patterns, including a source of insect attracting lights and a housing configured to be mounted on a flat surface. The housing has multiple openings therein for reflecting insect attracting lights; wherein the housing and the lights cooperate to form a light pattern directed in a display pattern that can surround the housing. Additionally, the housing includes an adhesive for the immobilization of insects that enter the housing. Although the fly trap of Nelson is similar in nature and relevant to the present invention it differs in that it fails to provide a foldable-single piece frame, and further differs in that it fails to provide a frame that is adapted to attract horseflies that believe they're attacking livestock.

U.S. Patent Publication No. 2009/0139155 to Kelders describes a ceiling system for catching insects in a building. The insect catching system includes a plurality of longitudinal beams, transverse beams, at least one insect catching device supported on the beams, and lamps for emitting ultraviolet light to attract the insects. Although the insect catching ceiling system of Kelders is similar in nature and relevant to the present invention, it differs in that it provides a flat surface instead of having a rectangular frame that is adapted to attract horseflies that believe they're attacking livestock from below.

The present invention relates to a device designed to attract and catch flies of the Genus Tabanus, in particular Horseflies and Greenhead flies. The device is a passive flycatcher that is adapted to catch flies without the use of lights, foods, and chemical attractants to bait the flies into entering the device. The device further comprises an article of manufacture is constructed of a single piece of material having sides that are adapted to tuck into each other to provide a sealed connection that establishes an upright, rectangular structure having an open bottom. The box further includes cutout sections that give the box the appearance of having legs that might resemble that of livestock. Since flies of the genus Tabanus required to feed on blood before they are able to lay their eggs, the box of the present invention is designed to resemble the legs of livestock, and thus be attractive for the fly who is trying to attack an animal believing that it will receive blood. Greenheads and Horseflies prefer to attack livestock by flying between their legs and attacking from underneath where the animals have less protection. Believing the box is an animal, the flies fly between the cutouts of the device and fly upwards towards the sunlight showing through the device. The flies then become trapped on an adhesive material attached to the box until they are removed from the box at a later time.

In view of the drawbacks of the prior art devices, it is shown that the prior art has several known setbacks and that the present invention is substantially divergent in design elements from the prior art and subsequently it is clear that there is a need in the art for an improvement to existing insect catching devices. In this regard the instant invention substantially fulfills these needs.

### SUMMARY OF THE INVENTION

In view of the foregoing disadvantages inherent in the known types of catching devices of flying insects now present in the prior art, the present invention provides a new fly catcher wherein the same can be utilized for providing convenience for the user when the user wishes to catch aggressive flies without the use of chemicals or pesticides that might cause harm to a person or their pets.

The fly catching device of the present invention is designed for those who want to reduce the population of flies that are capable of repeated bites and are further capable of spreading disease among humans and livestock. The device comprises a single piece design that is foldable into a rectangular shape having fastening features located thereon. The devices includes a dark exterior, cutouts designed to resemble the legs of livestock, and an open top area having a clear adhesive adapted to catch the problematic insects.

The fly catching device of the present invention is lightweight, easily portable, and includes a placement for a weighted device to improve stability of the device. The device reduces horsefly and greenfly populations, lacks pollutants to attract the flies, and is ideal for use in most environments, including that of homes, offices, commercial properties, beaches and animal farms.

It is therefore an object of the present invention to provide a new and improved fly catching device that has all of the advantages of the prior art and none of the disadvantages.

It is another object of the present invention to provide a fly catching device and article of manufacture having a single piece construction.

Another object of the present invention is to provide a fly catching device configured to resemble the physiology of a legged, warm-blooded animal.

Yet another object of the present invention is to provide a fly catching device having a removable adhesive configured for catching the flies that is readily replaceable and removable with the deceased flies still thereattached.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates an overhead perspective view of the preferred embodiment of the fly catching device of the present invention.

FIG. 2 illustrates a perspective view of the preferred embodiment of the article of manufacture of the present invention, which includes a single piece, folding panel design.

FIG. 3 illustrates a view of the removal of an adhesive material within the interior of the preferred embodiment of the fly catching device.

FIG. 4 illustrates a view of a weighted device within the interior of the fly catching device of the present invention.

### DETAILED DESCRIPTION OF THE INVENTION

Reference is made herein to the attached drawings. Like reference numerals are used throughout the drawings to depict like or similar elements of the fly catching device. For the purposes of presenting a brief and clear description of the present invention, the preferred embodiment will be discussed as used for catching aggressive flies without active participation of the user or without the use of chemicals or pesticides that might cause harm to a person or their pets. The figures are intended for representative purposes only and should not be considered to be limiting in any respect.

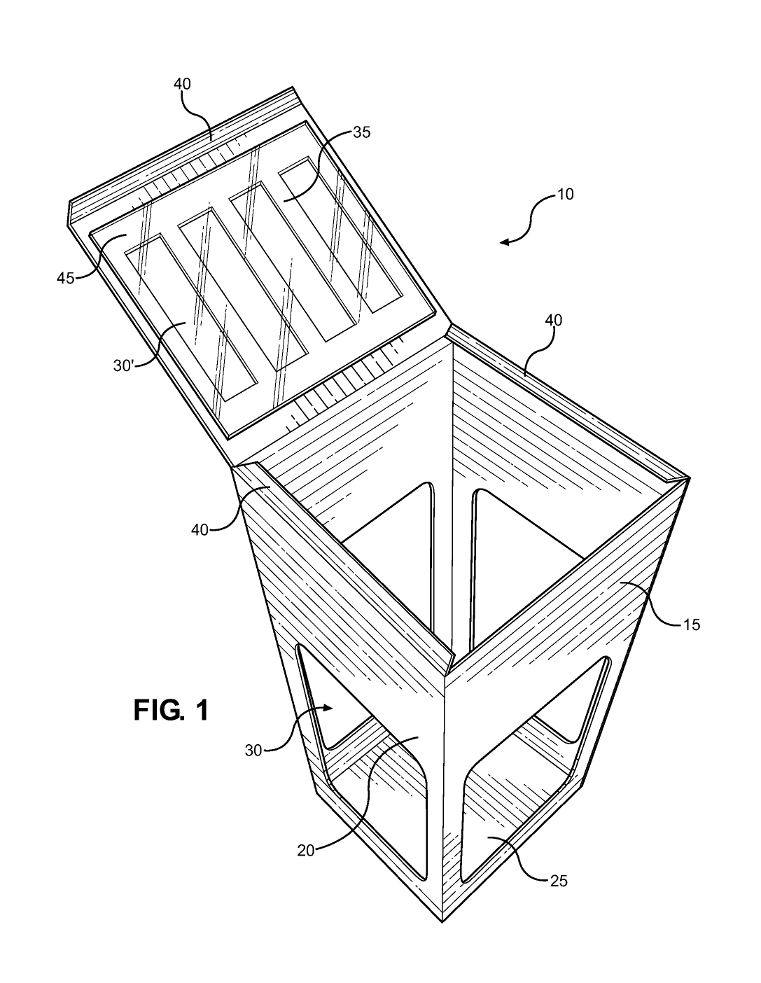

Referring now to FIG. 1, there is shown an overhead perspective view of the preferred embodiment of the fly catching device 10 of the present invention. The device 10 is made of a single-piece frame 15 and is comprised of a dark-colored plastic, fiberboard, or other suitable material. The device 10 includes a single-piece frame 15 having sidewalls 20, a base 25, and an upper surface 35 that is secured to the sidewalls 20 by lips 40 that enable closure of the device 10. Furthermore, the device includes a plurality of side openings 30 located along the sides 20 and on the upper surface 35 of the device.

The sides 20 of the device 10 include openings 30 to encourage flies to enter the device 10 by being designed to resemble the legs of warm-blooded livestock. Female horseflies and greenhead flies are anautogenous and require a blood meal before they are able to effectively reproduce. Therefore, during seasons that encourage breeding, fly attacks on humans and livestock are greatly increased. The sides 20 of the device 10 include openings 30 that are near the base 25 of the device 10 to resemble the legs of livestock, including that of cattle, sheep, goats, pigs, and other similar mammals having four legs.

The side walls 20 are designed to encourage flies who are attempting to feed to enter the device 10 by resembling the legs of an animal. The flies enter the device 10 through the openings 30 of the sidewalls 20 believing that they are the legs of livestock. When the flies see sunlight through the openings 30′ of the upper surface 35, the flies then fly upwards towards the upper surface 35 of the device 10 believing they are attacking the underbelly of an animal. The flies then become adhered to an adhesive 45 on the upper surface 35 of the frame 15. The adhesive 45 may be placed along the inside of the upper surface 35, or alternatively along the outside of the upper surface 35. Placement along the outside of the upper surface 35 allows a user to quickly replace the adhesive 45 without first opening the upper surface 35 of the structure.

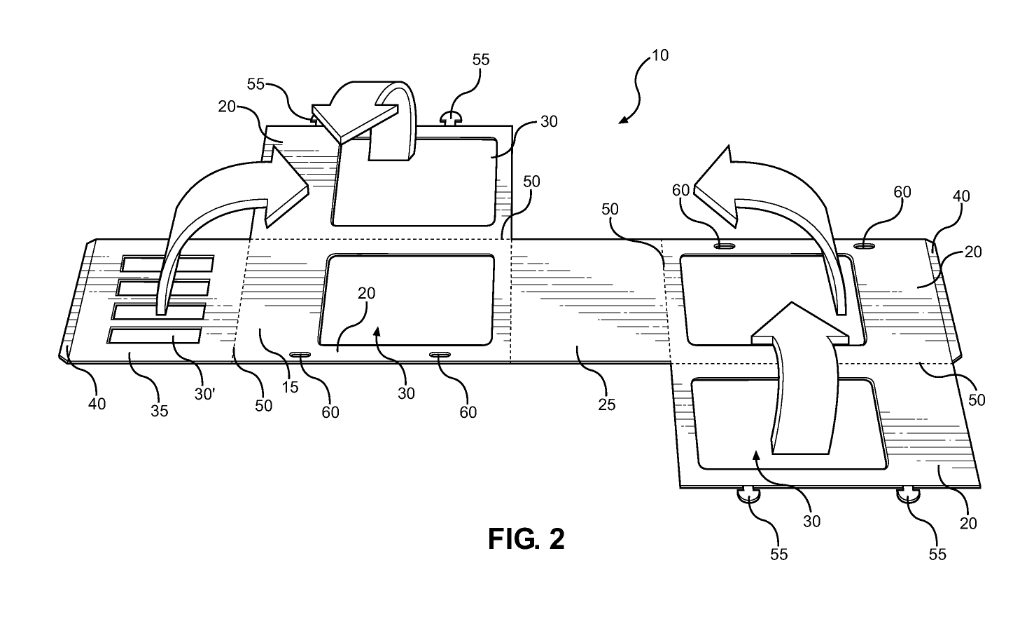

FIG. 2 illustrates the single-piece construction of the preferred embodiment of the fly catching device 10. The single-piece frame 15 design eliminates the need for welding, gluing, or otherwise permanently fastening the device together. The frame 15 of the device 10 includes sidewalls 20 having openings 30 thereon, a base 25, an upper surface 35 having openings 30′, and fold lines 50 that facilitate folding between the portions of the frame 15. The fold lines 50 enable folding between each of the sidewalls 20, between opposing sidewalls and the base 25, and along the upper surface 35 of the frame 15.

To assemble the fly catching device 10, first one sidewall 20 is folded along the fold lines 50 at its connection with the base 25. Next, the opposing sidewall 20 is similarly folded along its fold lines 50 with the other side of the base 25. Then the sidewalls 20 that include tabs 55 are folded over at the sidewall fold lines 50 to a position near the opposing sidewalls 20. The tabs 55 of each sidewall 20 are inserted into the slots 60 of an opposing sidewall 20 and are secured therein to complete the rectangular shape of the fly catching device 10 and eliminate the need to weld or glue the device to facilitate stability. To close the fly catching device 10, upper surface 35 is folded at its fold line 50 over the opening created by the sidewalls 20 of the frame 15. The lip 40 of the upper portion 35 is then folded downward and into the area of the lips 40 of the sidewalls 20 to close the device 10.

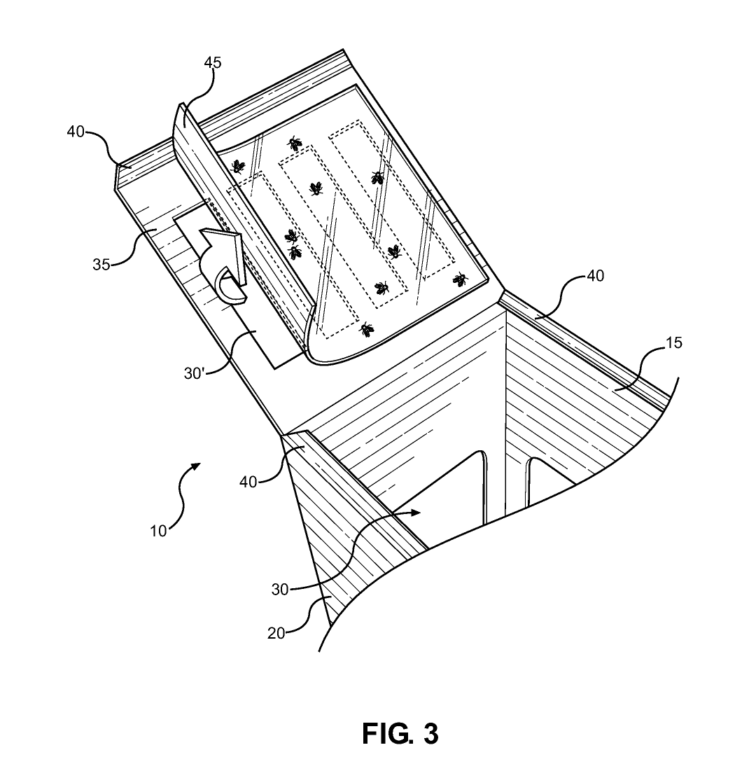

Referring to FIG. 3, there is shown an illustration of the adhesive material 45 of the fly catching device 10 of the present invention. After the frame 15 as shown in FIG. 2 has been assembled, an adhesive material 45 may be attached to the interior or exterior of the upper surface 35 of the fly catching device 10. The adhesive material 45 may be comprised of a transparent polyethylene material or other suitable transparent material. The transparent material may have one side coated with a sticky adhesive that is adapted for retaining insects that come into contact with the transparent material and the outer edges of the opposing side may have a similar adhesive applied to the edges of the material in order to facilitate attachment to the interior of the upper surface 35 of the frame 15. If the adhesive is adapted to be placed along the exterior of the upper surface 35, the adhesive may be tacky only on one side, whereby the device is adhered to the upper surface 35 and is adapted to capture flies along a single side of the adhesive layer. Once the adhesive material 45 is attached to the interior of the upper surface 35, the upper surface 35 may be closed to complete the assembly of the fly catching device 10.

When flies enter the openings 30 of the sidewalls 20, they believe they are flying under the legs of an animal. The flies then fly upwards towards the openings 30′ of the upper surface 35 while intending to land on the underbelly of an animal. The flies become adhered to the adhesive material 45 located on the interior of the upper surface 35 and remain there until the user removes the material 45. To remove the material 45, the user opens the upper surface 45 and moves the upper surface 35 away from the lips 40 of the sidewalls 20. The user can then peel the adhesive material 45 away from the upper surface 35 and dispose of the material 45. A new adhesive material 45 can then be adhered to the inner surface of the upper portion 35 of the device 10 to again facilitate catching of flies.

Having the adhesive material 45 positioned on the interior of the device 10 is desired because it enables the material 45 to adhere onto flies landing on all portions of the upper surface 35 and not just over the openings 30′ of the upper surface 35, however it is within the scope of the invention to attach an adhesive material 45 to the outer surface of the upper portion 35 of the device 10. Having the adhesive material 45 positioned on the outer surface of the device 10 would enable a person to remove the adhesive material 45 without having the user be required to lift the upper surface 10 of the device 10 and permit a multitude of flies to escape the device 10. It is further within the scope of the fly catching device 10 present invention to have the adhesive material 45 sized and shaped to cover only the openings 30′ of the upper surface 35 in order to enable a user to remove only the sections of adhesive material 45 that comprise insects stuck to the material 45.

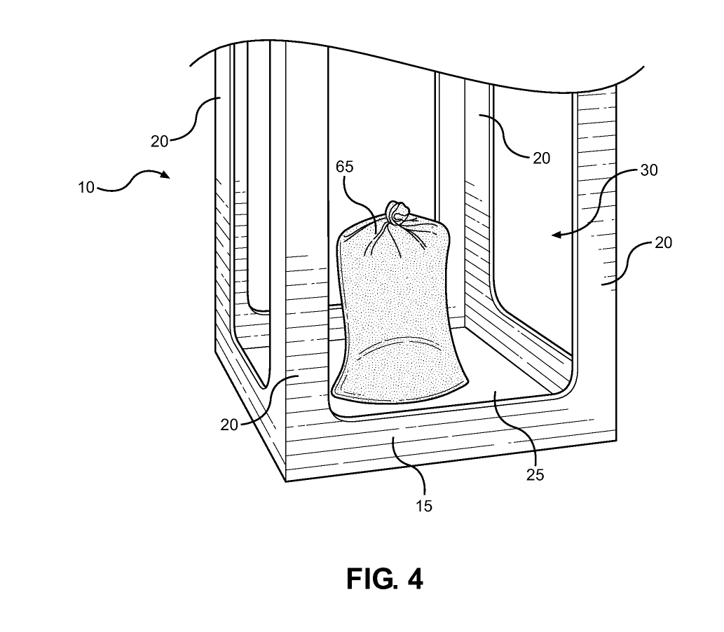

Referring to FIG. 4, there is shown a perspective view of the interior of the fly catching device 10 having a weighted material 65 therein. The fly catching device 10 is designed for use in both indoors and outdoors and the base 25 of the device 10 comprises a heavier material than the rest of the frame 15, however there may be weather conditions in which the wind might tip over the fly catching device. For situations wherein the weather might displace the fly catching device 10, there is provided a weighted material 65 therein. The weighted material 65 may be a bag filled with water, sand, or other suitable material capable of being placed on the base 25 of the device 10 to anchor the fly catching device 10 in place.

The present invention is designed for users who wish to lessen the amount of aggressive flies in an area without requiring an act of participation of the part of the user, or the use of lights, baits and chemicals to attract the flies. Specifically, the passive fly catcher 10 of the present invention is adapted to attract and catch flies of the genus Tabanus, in particular horseflies and greenhead flies. The device 10 comprises a single-piece frame 15 having sidewalls 20 having openings 30, a base 25, and an upper surface 35 having openings 30′ included thereon. The openings 30 of the sidewalls 20 encourage insects to enter the device by facilitating the appearance that the sidewalls 20 of the fly catching device 10 are the legs of livestock.

Females of the genus Tabanus must feed on blood before they are capable of effectively reproducing, and thus the greenhead and horseflies fly low to the ground and enter the passive fly catching device 10 believing they are flying under the legs of livestock. The flies then fly upwards towards the sunlight shining through the openings 30′ of the upper surface 35 of the device 10 intending to land on the underbelly of livestock where there is less protection against their bites. When the flies reach the upper surface 35 of the frame 15, they become stuck to the adhesive material 45 that is placed on either the interior or exterior of the upper surface 35. The adhesive material 45 can be removed a later time when a sufficient amount of flies have been collected and a new adhesive material 45 then replaces the discarded adhesive 45.

The fly catching device 10 can be placed in the home, office, and outdoors, and is further dark in color to resemble the livestock that the flies might wish to attack. The dark color of the fly catching device 10 results in a warmer device than the surrounding that attracts flies via their heat sensing capability. The majority of the device is comprised of lightweight materials, however it is configured to sufficiently maintain its place in windy conditions. Furthermore, unlike known fly traps that require the tipping over of a device to remove the pests contained therein, the fly catch 10 of the present invention comprises a peel away adhesive 45 that facilitates easy removal of the trapped insects. Additionally, it is within the scope of the present invention to include modifications to the dimensions of the fly catching device 10 depending on the needs of the users; whereas commercial, residential, and sizes for camping purposes will differ. In this way the fly catching device 10 of the present invention serves to passively reduce a population of aggressive flies that have the potential to bite and spread disease to people and livestock.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A passive insect catching device resembling a legged-animal, comprising;
a largely rectangular frame comprising a single piece construction having a base, sidewalls, an upper portion adapted for closing said device;
wherein said sidewalls further comprise side openings adapted to allow entry of flying insects;
and wherein said upper portion is adapted to receive an adhesive material thereover that is adapted to retain flying insects thereto.

2) The insect catching device of claim 1, wherein said single piece construction further comprises:
a first pair of sidewalls adjoined along a fold line, said first pair of sidewalls adjoining said base along a fold line,
a second pair of sidewalls adjoining each other along a fold line, said second pair of sidewalls adjoining said base opposite of said first pair of sidewalls and along a fold line;
said upper portion adjoining one sidewalls of said second pair of sidewalls along a fold line;
said sidewall pairs further comprising tabs configured to mate with a slot of said opposing sidewall pair;
said upper portion further comprising a lip along a fold line that is adapted to fold downward and close off said frame when constructed.

3) The insect catching device of claim 1, wherein said adhesive material is configured to peel away from said upper portion of the device after use.

4) The insect catching device of claim 1, wherein said adhesive material is placed on the interior surface of said upper portion.

5) The insect catching device of claim 1, wherein said base comprises a heavier weight than the remainder of said frame in order to facilitate the stability of said device.

6) The insect catching device of claim 1, wherein a weighted material is adapted for placement on said base in order to facilitate the stability of said device.

7) The insect catching device of claim 1, comprising a plurality of openings on said upper surface.

8) The insect catching device of claim 1, comprising a plurality of openings on said upper surface, said adhesive material being transparent and adapted to cover over said plurality of opening of said upper surface.

9) The insect catching device of claim 1, wherein said rectangular frame comprises a dark color that is adapted to attract flies.

10) A method of constructing the insect catching device of claim 2, comprising the steps of:
folding said first pair of sidewalls perpendicularly with respect to said base along said adjoining fold line;
folding said second pair of sidewalls perpendicularly with respect to said base along said adjoining fold line;
folding said sidewall pairs together to form a rectangular shape by securing said sidewall pairs together using said tabs configured to mate with a slot of said opposing sidewall pair;
folding said upper portion along said fold line and folding down said upper portion lip to securing said upper portion to said sidewall pairs.
